(19) United States
(12) Patent Application Publication
(10) Pub. No.: US 2022/0295803 A1
(43) Pub. Date: Sep. 22, 2022

(54) PREPARATION METHOD OF LOW-SUGAR WHOLE POTATO FLOUR ENERGY BAR

(71) Applicant: Qingdao Agricultural University, Qingdao (CN)

(72) Inventors: Qingjie Sun, Qingdao (CN); Xuyan Dong, Qingdao (CN); Liang Liu, Qingdao (CN); Yuchang Liu, Qingdao (CN); Yang Li, Qingdao (CN); Changhong Hao, Qingdao (CN); Enmin Ji, Qingdao (CN)

(73) Assignee: Qingdao Agricultural University, Qingdao (CN)

(21) Appl. No.: 17/693,672

(22) Filed: Mar. 14, 2022

(30) Foreign Application Priority Data
Mar. 16, 2021 (CN) 202110278010.1

(51) Int. Cl. A21D 13/043; A21D 2/36; A21D 2/18

(52) U.S. Cl. CPC A21D 13/043; A21D 2/364; A21D 2/362; A21D 2/181; A21D 2/366; A21D 2/186

(57) ABSTRACT

The present disclosure belongs to the technical field of food processing. Use of sucrose and maltose as binders in the existing energy bars leads to high hardness and adhering tooth in energy bars. Aiming at the problem, the present disclosure provides a preparation method of a low-sugar whole potato flour energy bar. Using starch gel and sugar alcohol as binders, whole potato flour and dried honey powder are added to prepare the energy bar; the starch is gelatinized, the sugar alcohol is dissolved, and gelatinized starch and a sugar alcohol solution are mixed in a mass ratio of 2:1 to 1:1 to prepare the binder; the binder is mixed with stir-fried whole potato flour and the dried honey powder, stirred evenly, and subjected to mold pressing or cool forming to obtain the energy bar.

### CROSS REFERENCE TO RELATED APPLICATION(S)

This patent application claims the benefit and priority of Chinese Patent Application No. 202110278010.1, filed on Mar. 16, 2021, the disclosure of which is incorporated by reference herein in its entirety as part of the present application.

### TECHNICAL FIELD

The present disclosure belongs to the technical field of food processing, and in particular relates to a preparation method of a low-sugar whole potato flour energy bar.

### BACKGROUND ART

With the acceleration of the pace of life, people are increasingly inclined to choose foods that can quickly take in energy, supplement nutrients and regulate body functions in addition to regular diets. The energy bar is a convenient, instant, nutritious bar-shaped food that can quickly replenish energy, and has the advantages of small size, light weight, and convenience to carry, and is welcomed by consumers. In the early 1990s, energy bar food began to emerge in developed countries such as Europe and the United States. In the past 10 years, they have grown from more than 10 varieties to more than 500 ones. Their functions, packagings, and flavors are dazzling. Energy bars have developed from athlete special food into a large category of general functional food. In 2018, the output value of energy bars reached RMB 9 billion in China, and the overall market size reached about RMB 30.5 billion. Therefore, in response to different ages, different occupations and other special nutritional needs, the development of full nutritional energy bars with rich taste, compact packaging, convenience to carry, high-quality ingredients, comprehensive nutrition and multiple body regulation functions has a very broad market prospect and economic benefits.

Traditional energy bars generally use sucrose and maltose as binders, resulting in energy bars that have high hardness, high dryness, poor cohesiveness, poor taste, sticky teeth, and the like, and excessive sugar intake can cause dental caries, obesity and other health problems.

### SUMMARY

Use of sucrose and maltose as binders in the existing energy bars leads to high hardness and adhering tooth in energy bars. In view of the problem, an objective of the present disclosure is to provide a preparation method of a low-sugar whole potato flour energy bar. Starting from improving binder preparation, the method improves the taste of the energy bar.

To achieve the above objective, the present disclosure adopts the following technical solution:

A preparation method of a low-sugar whole potato flour energy bar is provided. Using starch gel and sugar alcohol as binders, whole potato flour and dried honey powder are added to prepare the energy bar, including the following steps:

step 1, starch gelatinization: gelatinizing the starch and storing at 90° C. for later use;

step 2, sugar alcohol dissolution: putting the sugar alcohol in a jacketed kettle, heating at 100-120° C., and constantly stirring until the sugar alcohol is dissolved completely, to obtain a sugar alcohol solution;

step 3, binder preparation: mixing gelatinized starch and the sugar alcohol solution in a mass ratio of 2:1 to 1:1, constantly stirring, boiling a resulting mixture at 120-140° C. in an open manner until water evaporation, and cooling the mixture to 90° C. to obtain the binder; and

step 4, energy bar production: preprocessing the adjuvants according to properties thereof, mixing a binder obtained in step 3 with preprocessed adjuvants in a mass ratio of (40-70):(30-70), stirring evenly, and conducting mold pressing or cool forming to obtain the energy bar.

Further, the starch in step 1 may be selected from the group consisting of corn starch, cassava starch, potato starch, and modified starch acceptable in food; further, the modified starch may be selected from the group consisting of acidified starch and crosslinked starch.

Further, the starch gelatinization in step 1 may be specifically achieved by: mixing the starch with water in a mass ratio of 1:6 to 1:10, sealing and gelatinizing the starch in boiling water for 30-60 min.

Further, the sugar alcohol in step 2 may be selected from the group consisting of maltitol, sorbitol, and a mixture of both, and the maltitol and the sorbitol may have a mass ratio of 2:1 to 3:1 in the mixture.

Further, the gelatinized starch and the sugar alcohol solution in step 3 may have a mass ratio of 1.5:1.

Further, stir-fried whole potato flour in step 4 may be commercially available whole potato flour stir-fried for 5-10 min.

Further, the adjuvants may be the whole potato flour and the dried honey powder, the whole potato flour in step 4 may be processed by stir-frying, and the binder, the stir-fried whole potato flour, and the dried honey powder may have a mass ratio of (40-70):(30-50):(3-5).

The present disclosure has the following beneficial effects: In the present disclosure, the sugar alcohol replaces sucrose and binds to the starch gel to prepare the binder, and the low-sugar whole potato flour energy bar is prepared in combination with nutrition characteristics of the whole potato flour; the product is proper in hardness, strong in cohesiveness, good in taste and non-sticky to teeth.

### DETAILED DESCRIPTION OF THE EMBODIMENTS

The present disclosure will be further described in detail below in conjunction with specific examples.

### Example 1

(1) Starch gelatinization: potato starch was mixed with water in a mass ratio of 1:6, sealed and gelatinized in boiling water for 30 min, constantly stirred, and stored at 90° C. for later use to obtain gelatinized starch;

(2) sugar alcohol dissolution: the sugar alcohol was put in a jacketed kettle, heated at 100-120° C., and constantly stirred until the sugar alcohol was dissolved completely, to obtain a sugar alcohol solution;

(3) binder preparation: gelatinized starch was mixed with the sugar alcohol solution in a mass ratio of 1:1, and constantly stirred; a resulting mixture was boiled at 120° C. in an open manner until water evaporation, and cooled to 90° C. to obtain the binder; and

(4) energy bar production: commercially available whole potato flour was stir-fried in a dry pot for 5 min, the binder obtained in step 3 was mixed with the stir-fried whole potato flour and dried honey powder (the binder, the stir-fried whole potato flour and the dried honey powder had a mass ratio of 40:50:3), stirred evenly, and subjected to mold pressing or cool forming to obtain an energy bar.

### Example 2

(1) Starch gelatinization: corn starch was mixed with water in a mass ratio of 1:10, sealed and gelatinized in boiling water for 60 min, constantly stirred, and stored at 90° C. for later use to obtain gelatinized starch;

(2) sugar alcohol dissolution: sorbitol was put in a jacketed kettle, heated at 120° C., and constantly stirred until the sugar alcohol was dissolved completely, to obtain a sugar alcohol solution;

(3) binder preparation: gelatinized starch was mixed with the sugar alcohol solution in a mass ratio of 1.5:1, the binder was mixed with stir-fried whole potato flour and dried honey powder in a mass ratio of 50:60:5, and constantly stirred; a resulting mixture was boiled at 140° C. in an open manner until water evaporation, and cooled to 90° C. to obtain the binder; and

(4) energy bar production: commercially available whole potato flour was stir-fried in a dry pot for 8 min, the binder obtained in step 3 was mixed with the stir-fried whole potato flour and dried honey powder (the binder, the stir-fried whole potato flour and the dried honey powder had a mass ratio of 50:50:3), stirred evenly, and subjected to mold pressing or cool forming to obtain an energy bar.

### Example 3

(1) Starch gelatinization: acidified starch was mixed with water in a mass ratio of 1:8, sealed and gelatinized in boiling water for 30 min, constantly stirred, and stored at 90° C. for later use to obtain gelatinized starch;

(2) sugar alcohol dissolution: maltitol was put in a jacketed kettle, heated at 120° C., and constantly stirred until the sugar alcohol was dissolved completely, to obtain a sugar alcohol solution;

(3) binder preparation: gelatinized starch was mixed with the sugar alcohol solution in a mass ratio of 1:1, and constantly stirred; a resulting mixture was boiled at 120° C. in an open manner until water evaporation, and cooled to 90° C. to obtain the binder; and

(4) energy bar production: commercially available whole potato flour was stir-fried in a dry pot for 10 min, the binder obtained in step 3 was mixed with the stir-fried whole potato flour and dried honey powder (the binder, the stir-fried whole potato flour and the dried honey powder had a mass ratio of 70:50:5), stirred evenly, and subjected to mold pressing or cool forming to obtain an energy bar.

### Example 4

(1) Starch gelatinization: cassava starch was mixed with water in a mass ratio of 1:8, sealed and gelatinized in boiling water for 45 min, constantly stirred, and stored at 90° C. for later use to obtain gelatinized starch;

(2) sugar alcohol dissolution: a mixture of maltitol and sorbitol in a mass ratio of 2:1 was put in a jacketed kettle, heated at 110° C., and constantly stirred until the sugar alcohol was dissolved completely, to obtain a sugar alcohol solution;

(3) binder preparation: gelatinized starch was mixed with the sugar alcohol solution in a mass ratio of 2:1, and constantly stirred; a resulting mixture was boiled at 130° C. in an open manner until water evaporation, and cooled to 90° C. to obtain the binder; and

(4) energy bar production: commercially available whole potato flour was stir-fried in a dry pot for 5 min, the binder obtained in step 3 was mixed with the stir-fried whole potato flour and dried honey powder (the binder, the stir-fried whole potato flour and the dried honey powder had a mass ratio of 40:40:3), stirred evenly, and subjected to mold pressing or cool forming to obtain an energy bar.

### Example 5

(1) Starch gelatinization: starch crosslinked with sodium trimetaphosphate was mixed with water in a mass ratio of 1:8, sealed and gelatinized in boiling water for 30 min, constantly stirred, and stored at 90° C. for later use to obtain gelatinized starch;

(2) sugar alcohol dissolution: a mixture of maltitol and sorbitol in a mass ratio of 3:1 was put in a jacketed kettle, heated at 120° C., and constantly stirred until the sugar alcohol was dissolved completely, to obtain a sugar alcohol solution;

(3) binder preparation: gelatinized starch was mixed with the sugar alcohol solution in a mass ratio of 1.5:1, and constantly stirred; a resulting mixture was boiled at 120° C. in an open manner until water evaporation, and cooled to 90° C. to obtain the binder; and

(4) energy bar production: commercially available whole potato flour was stir-fried in a dry pot for 10 min, the binder obtained in step 3 was mixed with the stir-fried whole potato flour and dried honey powder (the binder, the stir-fried whole potato flour and the dried honey powder had a mass ratio of 60:50:3), stirred evenly, and subjected to mold pressing or cool forming to obtain an energy bar.

The control group of Example 1 was basically the same as this example. The difference was that: the binder in the example was replaced with egg white, white sugar, flour and vegetable oil of the same mass; after the egg white and white sugar were beaten, the flour was added, mixed with the vegetable oil evenly and used as a binder.

The control group of Example 2 was basically the same as this example. The difference was that the binder in the example was replaced with sucrose of the same mass, and the sucrose was boiled into a syrup under the same conditions as the binder.

The control group of Example 3 was basically the same as this example. The difference was that the sugar alcohol in the example was replaced with sucrose of the same mass.

The foregoing Examples 1 to 5 and control groups were evaluated according to the standards in Table 1. After evaluation, the energy bars prepared in the foregoing Examples 1 to 5 were suitable in hardness, strong in cohesiveness, good in taste, and non-sticky to teeth. See Table 2 for details.

TABLE 1
Sensory evaluation standards for energy bars

| | Scoring standard | | | |
|---|---|---|---|---|
| Item | Excellent | Good | Fair | Poor |
| Appearance (30) | Complete, | Relatively | Not too | Incomplete, |
| Excellent (26- | without detritus | complete, with | complete, with | crispy, and |
| 30), good (21- | | little detritus | more detritus | unable to |
| 25), fair (16-20), | | | | maintain a |
| and poor (11-15) | | | | complete |
| | | | | appearance |
| Color (30) | Uniform and | Relatively | Not uniform and | Not uniform and |
| Excellent (26- | lustrous | uniform and | less lustrous | lackluster |
| 30), good (21- | | lustrous | | |
| 25), fair (16-20), | | | | |
| and poor (11-15) | | | | |
| Flavor and taste | Rich in potato | Light in potato | Shallow in | Without potato |
| (40) | aroma, free from | flavor, free from | potato flavor, | flavor or with |
| Excellent (31- | unpleasant odor, | unpleasant odor, | with mild | heavier |
| 40), good (21- | good in taste, | good in taste, | unpleasant odor, | unpleasant odor |
| 30), fair (11-20), | non-sticky to | with a few | slightly good in | than the potato |
| and poor (1-10) | teeth, with | particles sticky | taste, with | flavor, poor in |
| | afteraste after | to teeth, without | particles sticky | taste, with |
| | eating, and not | afteraste after | to teeth, without | particles sticky |
| | choking | eating, and | afteraste after | to teeth, without |
| | | slightly choking | eating, and | afteraste after |
| | | | choking | eating, and |
| | | | | choking |

TABLE 2
Evaluation scoring of Examples 1 to 5

| Score | Example 1 | Example 2 | Example 3 | Example 4 | Example 5 |
|---|---|---|---|---|---|
| Appearance | 28 | 28 | 27 | 26 | 25 |
| Color | 26 | 27 | 27 | 27 | 28 |
| Flavor and | 35 | 37 | 36 | 36 | 35 |
| taste | | | | | |
| Total score | 89 | 92 | 90 | 89 | 88 |

TABLE 3
Evaluation scoring of the control groups

| | Control group | Control group | Control group |
|---|---|---|---|
| Score | of Example 1 | of Example 2 | of Example 3 |
| Appearance | 23 | 24 | 22 |
| Color | 22 | 24 | 25 |
| Flavor and taste | 25 | 21 | 18 |
| Total score | 70 | 69 | 70 |

The above examples are only intended to describe the preferred implementation of the present disclosure and not intended to limit the scope of the present disclosure. Various alterations and improvements made by those of ordinary skill in the art based on the technical solution of the present disclosure without departing from the design spirit of the present disclosure shall fall within the scope of the appended claims of the present disclosure.

What is claimed is:

1. A preparation method of a low-sugar whole potato flour energy bar, wherein the energy bar comprises a binder and adjuvants, the binder comprises starch and sugar alcohol, the adjuvants at least comprise whole potato flour and dried honey powder, and the preparation method comprises the following steps:
step 1, starch gelatinization: gelatinizing the starch and storing at 90° C. for later use;
step 2, sugar alcohol dissolution: putting the sugar alcohol in a jacketed kettle, heating at 100-120° C., and constantly stirring until the sugar alcohol is dissolved completely, to obtain a sugar alcohol solution;
step 3, binder preparation: mixing gelatinized starch and the sugar alcohol solution in a mass ratio of 2:1 to 1:1, constantly stirring, boiling a resulting mixture at 120-140° C. in an open manner until water evaporation, and cooling the mixture to 90° C. to obtain the binder; and
step 4, energy bar production: preprocessing the adjuvants according to properties thereof, mixing a binder obtained in step 3 with preprocessed adjuvants in a mass ratio of (40-70):(30-70), stirring evenly, and conducting mold pressing or cool forming to obtain the energy bar.

2. The preparation method of a low-sugar whole potato flour energy bar according to claim 1, wherein the starch in step 1 is selected from the group consisting of corn starch, cassava starch, potato starch, and modified starch acceptable in food.

3. The preparation method of a low-sugar whole potato flour energy bar according to claim 1, wherein the modified starch is selected from the group consisting of acidified starch and crosslinked starch.

4. The preparation method of a low-sugar whole potato flour energy bar according to claim 1, wherein the starch gelatinization in step 1 is specifically achieved by: mixing the starch with water in a mass ratio of 1:6 to 1:10, sealing and gelatinizing the starch in boiling water for 30-60 min.

5. The preparation method of a low-sugar whole potato flour energy bar according to claim 1, wherein the sugar alcohol in step 2 is selected from the group consisting of maltitol, sorbitol, and a mixture of the maltitol and sorbitol, wherein the maltitol and the sorbitol have a mass ratio of 2:1 to 3:1 in the mixture.

6. The preparation method of a low-sugar whole potato flour energy bar according to claim 1, wherein the gelatinized starch and the sugar alcohol solution in step 3 have a mass ratio of 1.5:1.

7. The preparation method of a low-sugar whole potato flour energy bar according to claim 1, wherein stir-fried whole potato flour in step 4 is commercially available whole potato flour stir-fried for 5-10 min.

8. The preparation method of a low-sugar whole potato flour energy bar according to claim 1, wherein the adjuvants are the whole potato flour and the dried honey powder, the whole potato flour in step 4 is processed by stir-frying, and the binder, the stir-fried whole potato flour, and the dried honey powder have a mass ratio of (40-70):(30-50):(3-5).

9. The preparation method of a low-sugar whole potato flour energy bar according to claim 1, wherein the adjuvants further comprise at least one of nuts, dried fruit, and butter.
